(19) United States
(12) Patent Application Publication
(10) Pub. No.: US 2012/0284626 A1
(43) Pub. Date: Nov. 8, 2012

(54) METHOD AND SYSTEM TO USE AUDIENCE PARTICIPATION SYSTEM WITHIN A PRESENTATION SOFTWARE

(75) Inventor: Vikas Vasudeo JOSHI, Pune (IN)

(73) Assignee: HARBINGER KNOWLEDGE PRODUCTS PRIVATE LIMITED

(21) Appl. No.: 13/461,003

(22) Filed: May 1, 2012

(30) Foreign Application Priority Data
May 3, 2011 (IN) 1373/MUM/2011

(51) Int. Cl. G06F 3/01; G06F 15/16

(52) U.S. Cl. 715/730

(57) ABSTRACT

The present invention provides a method and a system to involve audience in presentations over a communication network. The method includes providing the presenter with an Audience Response System Presenter Component having a presentation software with an interactive component for presenting an information and capturing audience inputs connected to the presenter's session and displaying it appropriately. Further, enabling the audience in a session to connect to a Server by using an Audience Response System Audience Component. Furthermore, enabling the presenters and audiences a better real time interactive communication to collect, view and share responses. At last, providing for display varied types of interactions with the audience and collecting audience input to be displayed using presenting software and Audience Response System Presenter Component.

### FIELD OF THE INVENTION

The invention relates generally to the field of Audience Response System (“ARS”), and more particularly to, a method and system to involve audience in online presentations over a communication network along with in-class presentations, and allows presenters to involve audience by displaying various interactive elements in a form which can be accessed by audience from all kinds of devices having access to network. The present invention provides the presenters and audiences a better real time interactive communication to collect, view and share responses. The invention also relates to a method and system that allows presenters to use the ARS with their interactive element within the presentation software.

### BACKGROUND OF THE INVENTION

With the advent of mobile technology and internet accessibility, presentations have moved beyond face to face demos. The ARS are usually a set of hand held devices which are used to involve audiences in presentations. Most of the known ARSs use Infrared (IR), Radio Frequency (RF) based devices to allow audience to participate, and allow participants to respond in a multiple choice questions format in a presentation environment such as class rooms, quiz shows, etc. Certain known ARSs also permit remote participant, who is unable to be physically present, to participate, however, limited flexibility and features. Such systems lack superior interactive capability between the presenter and the audience with greater flexibility to the presenter and the audience. The present invention seeks to overcome such limitations of the prior known ARSs.

### BRIEF DESCRIPTION OF THE DRAWINGS

The aspects and features of the invention can be better understood with reference to the drawings. The drawings are not necessarily to scale, emphasis instead generally being placed upon illustrating the principles of the invention wherein:

FIG. 1 shows a schematic block diagram of a system to involve audience in presentations over a communication network in accordance with the present invention;

FIG. 2 shows a schematic block diagram of an Audience Response System Audience Component of the system of FIG. 1; and

FIG. 3 shows a schematic block diagram of a method to involve audience in presentations over a communication network in accordance with the present invention.

### DESCRIPTION OF THE INVENTION

The present invention is an entirely new and better way of participation by audiences and sharing of responses in presentations.

In accordance with the present invention, the presenter 113 is allowed to involve audience 103 in an online presentation environment including, but not limiting to, in-class presentations, through various different input methods such as drag and drop, sequencing, etc. The present system allows the presenters to use the ARS with the aid of the interactive element 112 present within the presentation software 111.

The present invention discloses an ARS that allows presenters 113 to involve audience 103 by displaying various interactive elements 112 in a form which can be accessed by audience 103 from all kinds of devices having access to network 101. The ARS invention provides a unique messaging format 104 for facilitating communication between audience 103 and the interactive element 112 used by the presenter 113 in the presenting software 111. It also provides a framework for displaying varied types of interactions to the audience 103 and collecting audience input which can then be provided to the interactive element 112 used by the presenter 113 in the presenting software 111. It also provides a unique way of combining people in the audience 103 in the form of groups which helps group collaboration and team work within the audience. These groups are identified by a unique group ID 211.

The present invention provides system and method for free flow of communication between presenter 113 and audience 103 over a network 105 with interactive capability in it.

In accordance with the present invention, the ARS includes at least one presenter communication device 109 comprising of presentation software 111, which is operable by presenter 113, at least one communication device having network 101, which is operable by audience 103, a ARS Server 108 and networking means. It should be understood that communication device having network means includes any communication devices such as cell phones, smart-phones, laptop computers, tablet PC and like which have access to network. It should also be understood that Network could be available in the form of internet, Wi-Fi, LAN, intranet and like where audience communication devices 101 are able to access the ARS Server 108.

In accordance with an embodiment of the invention, the audience 103 in a presentation session uses their devices having network connection 101 to connect to the ARS Server 108 through Audience Response System Audience Component (“ARSAC”) 102. The ARS Server 108 and the ARSAC 102 communicate over network 105 in a unique message format 107. Similarly, the Presenter 113 in a session uses the presentation software 111 which has an interactive element 112 in it, to capture audience inputs connected to the presenter's session and display it appropriately as per the type of interactive element. To share information with the audience 103, interactive element 112 communicates the required information to the Audience Response System Presenter Component (“ARSPC”) 110. The ARSPC 110 shares this information in a unique message format 104 with the ARS Server 108 over network 105 for further processing. The ARS Server 108 shares this message 106 to the audience 103 which are connected to the presenter's session using the ARSAC 102. Further, the server is provided a presenter panel, which enables the presenter to view each of the audience which are logged in for the presentation and permit the audience to continue the presentation by providing meeting ID 216. The meeting 1D 216 enables the selected audience 103 to participate in the presentation.

In an embodiment of the invention, the ARS Server 108 can be divided into three components: the ARSPC 110, the ARSAC 102, and the ARS Server. 108

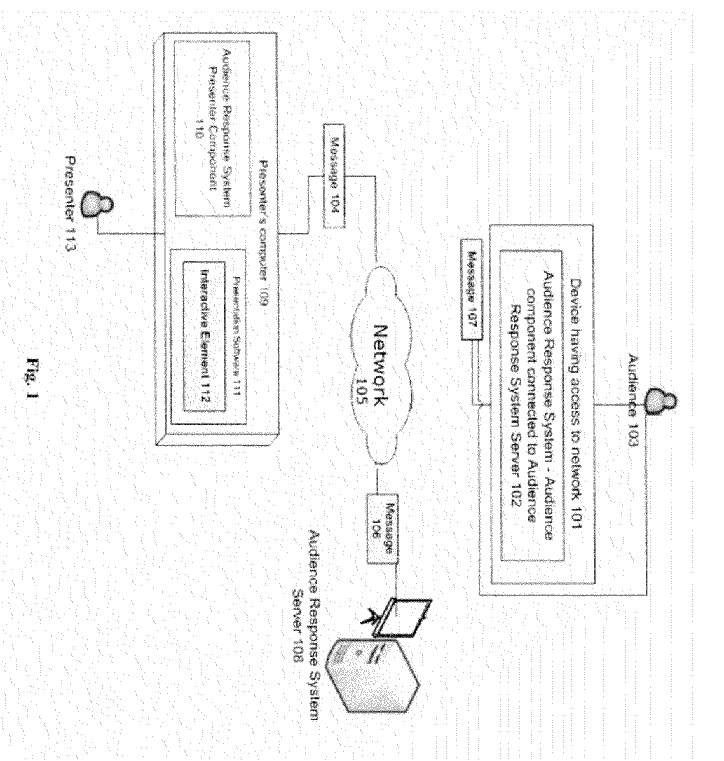

These aspects of the present invention are illustrated with reference to FIG. 1.

In yet another aspect of the present invention, the present invention provides secured access to the presentation content through creating user ID 209. Further, the ARSPC 110 interacts with ARSAC 102 using a unique messaging format 215 which consists of Meeting ID 216, Information Type 202, Information 203 and Group ID 211. The Meeting ID 216 in accordance with the present invention is a unique identifier which identifies the current session of the presenter 113 and allows audience 103 to connect to that session. This Meeting ID 216 also helps ARS Server 108 to send the required information only to the audience 103 connected to that session instead of broadcasting it to all the audience connected to ARS Server 108. Further, the Information type 202 specifies the type of Information 203 present in the message 215. Group ID 211 is a unique identifier for a specific selected group among the audience which helps the audience 103 to participate in groups to enhance team work. This messaging format is the binding factor between the ARSPC 110 and ARSAC 102.

In accordance with the present invention, the interactive element 112 of the presentation software 111 communicates with the ARSPC 110 to share information which requires input from audience 103. The Server Message Processor (“SMP”) 218 in the ARSPC 110, provided for such purposes, accepts this information and based on the type of information appends Information type 202 along with a Group ID 211 and creates a unique message. This message is then sent to the Server Message Communicator (SMC) 217 in ARSPC 110, provided for such purposes. The SMC 217 adds the unique Meeting ID 216 of the presenter 113, generated when the presenter logged into the ARS Server 108, to the message and sends it to the ARS Server 108 over the network 105. In accordance with the present invention, the ARS Server 108 has a Presenter Request Processor (“PRP”) 212 which processes every request coming from the ARSPC 110 and sends it to Audience Request Processor (“ARP”) 213 to send it across to all the audience connected to that Meeting ID 216. If the message has a Group ID 211, the message is then sent to only the selected audience logged into that specific Group. The ARP 213 sends a message consisting of Information type 202 and Information 203 to the Audience Message Communicator (“AMC”) 201 in the ARSAC 102. The AMC 201 accepts this message 210 and sends it to Audience Message Interpreter (“AMI”) 204 for further processing. Based on the Information type 202, the AMI 201 selects an appropriate Audience Interface Generator (“AIG”) 205, which displays the information 203 in appropriate format to the audience 103 through the Audience Interface 206.

In accordance with the present invention, audience 103 can provide their inputs based on the information 203 displayed on the Audience Interface 206 through their input device 101. Audience response in the form of user response 207 is captured by the Audience Interface 206 and is sent to AMC 201 for sending it to the presenter 113. The AMC 201 packages this response in a unique message format 208 which consists of Unique User ID 209 to identify the user from the audience and the response 207 of the user. This message 208 is then sent across network 105 to ARS Server 108 where ARP 213 accepts this message 208 for further processing. Based on the Unique User ID 209, the ARP 213 identifies the presenter 113 to which the user is connected to and accordingly forwards this information to PRP 212 to send it to the ARSPC 110. The SMC 217 in the ARSPC 110 accepts the user response and sends it to the SMP 218 for processing the message. The SMP 218 first sends the message for logging to Server Message Logger 219 and then sends the response 207 from the message to the Interactive Element 112 in the presentation component 111 of the presenter 113. Server Message Logger 219 logs the message for future reference, displaying the information through presenter panel and report generations for the presenter 113.

In an embodiment of the present invention, the present invention provides a unique way of combining people in the audience in the form of groups which helps group collaboration and team work within the audience.

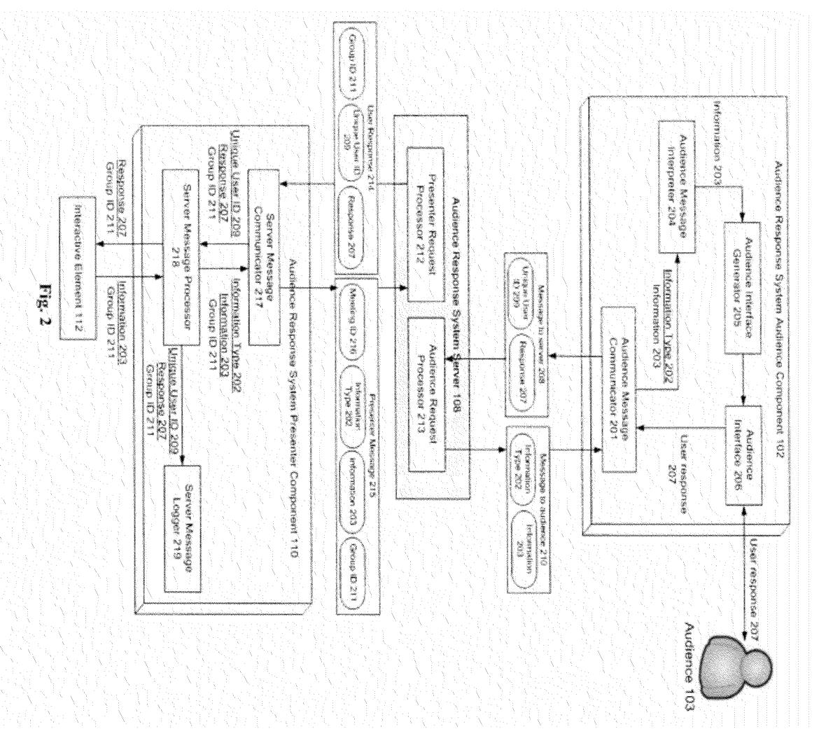

These aspects of the present invention are illustrated with reference to FIG. 2.

In yet another embodiment of the present invention, the functional components of ARS Server 108 for efficient processing of requests and information flowing between the ARSPC 110 and ARSAC 102, the PRP 212 comprises of two components: The Presenter Request Sender 302; and the Presenter Request Listener 301.

The Presenter Request Sender (“PRS”) 302 constantly listens to the requests coming from the presenter 113. The message from that presenter 215 is then sent to Audience Request Listener (“ARL”) 303 in the ARP 213 for sending it to all the audience 103 connected to that presenter 113 using the same Meeting ID 216. THE ARL 303 then sends the message only with the Information type 202 and Information 203 from the message to the audience 210 based on the Meeting ID 216 and Group ID 211 present in that message 215.

Similarly, whenever a user in the audience 103 responds to the information 203 using the ARSAC 102, the Audience Request Sender 304 in the ARP 213 accepts the message. The Audience Request Sender 304 is always in a listen mode for any inputs from the audience 103 and hence the response from the audience is processed instantly as soon as the audience responds to the information 203. The Audience Request Sender 304 then sends this message 208 to Presenter Request Listener (“PRL”) 301 for sending it across to the ARSPC 110 based on the Unique User ID 209 in the message. The PRL 301 accepts the message 209 and collates them all together in a message to send it to ARSPC 110 as soon as there is a request from ARSPC 110 for accepting the response. Thus, the PRL 301 provides a faster and efficient way of sending information to the ARSPC 110 instead of sending a single user request every time.

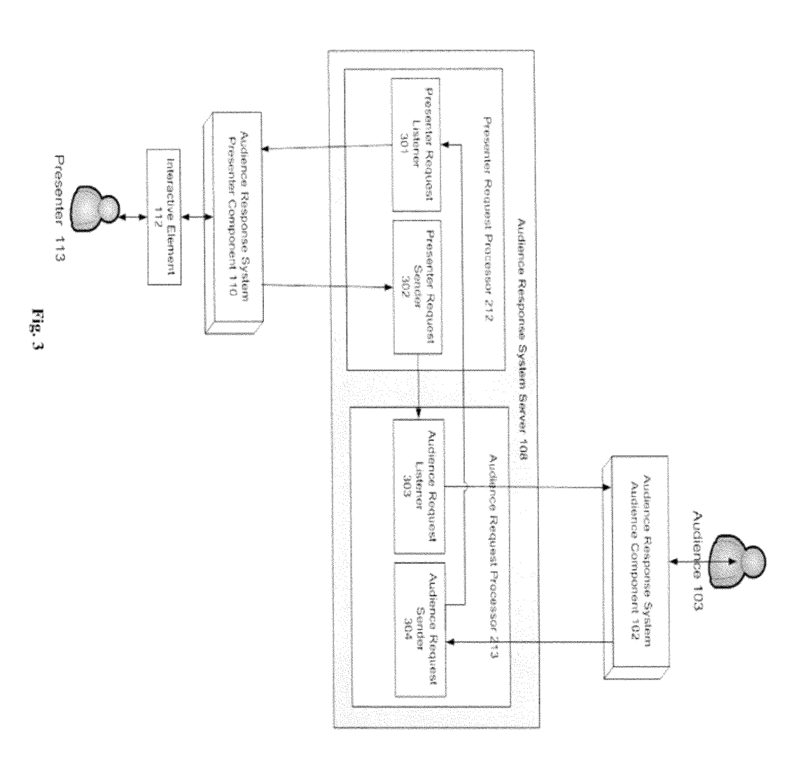

These aspects of the present invention are illustrated with reference to FIG. 3.

In another embodiment of the invention, simultaneously providing smart statistical analysis based on the responses by the audiences.

1. A method to involve audience in presentations over a communication network, the method comprising,
providing a presenter a presentation software with an interactive component having an audience response system presenter component for presenting information and capturing audience inputs connected to the presenter's session and displaying it appropriately;
enabling the audience in a session to connect to a Server by using an audience response system audience component;
enabling the presenters and audiences a better real time interactive communication to collect, view and share responses; providing for display varied types of interactions with the audience and collecting audience input to be displayed using presenting software and audience response system presenter component, wherein the audience response system presenter component generate reports based on communication there between; and
providing a presenter panel to enable the presenter to view each of the audience which are logged in for the presentation and permit the audience to participate by providing meeting ID.

2. The method as claimed in claim 1, wherein the audiences participate independently.

3. The method as claimed in claim 1, wherein the audiences participate in a group.

4. The method as claimed in claim 1, wherein the audiences participate anonymously.

5. The method as claimed in claim 1, wherein the interactive communications between the presenter and the audiences are in-class and online presentations, through various different input methods such as drag and drop, sequencing, games and like.

6. The method as claimed in claim 1, wherein the presenter and the audience is enabled to combine people in the audience in the form of groups which helps group collaboration and team work within the audience.

7. The method as claimed in claim 1, wherein a secured access is provided to the presentation content by providing user ID to participants.

8. The method as claimed in claim 1, wherein a Meeting ID is provided to identify the current session of the presenter and allows audience to connect to the session—
the Meeting ID also helps the Server to send the required information only to the audience connected to that session instead of broadcasting it to all the audiences connected to the Server thus providing secured access to the audience in that session.

9. A system to involve audience in presentations over a communication network, the system comprising,
at least one audience response system presenter component having a presentation software with an interactive component operable by the presenter for capturing audience inputs connected to the presenter's session and displaying it appropriately, wherein the audience response system presenter component generate reports based on communication there between;
at least one audience response system audience component having network, which is operable by audience; and
a Server connected to the audience response system presenter component and audience response system audience component, wherein the server selectively communicates messages from the audiences to the presenter during presentation, wherein the server includes a presenter panel enabling the presenter to view each of the audience which are logged in for the presentation and permit the audience to participate by providing meeting ID.

10. The system as claimed in claim 9, wherein the audience response system presenter component is a part of Presenter's computer and the audience response system audience component is a part of the Audience Response System Server, which can be used from a communication device having access to network.

11. The system as claimed in claim 9, wherein the audience response system presenter component, the Server and or the audience response system audience component communicates with each other over network in a message format.

12. The system as claimed in claim 9, wherein the audience response presenter component further comprises:
a Server Message Processor that accepts the information shared by the interactive element of the presentation software and based on the type of information appends Information type and creates a message;
a Server Message Communicator that receives the message created by the Server Message Processor and then adds Meeting ID of the presenter to the message and sends it to the Server; and
a Server Message Logger.

13. The system as claimed in claim 9, wherein the Server further comprises,
a Presenter Request Processor which processes requests coming from the presenter and sends it to a audience request processor; and
a Audience Request Processor which receives processed requests from the presenter request processor and further sends it across to all the audience connected to that Meeting ID through the audience response system audience component.

14. The system as claimed in claim 13, wherein the audience request processor or the Server receives messages from the audience message communicator or the audience response system audience component to identify the user from the audience and the response of the user, the message being then sent to the presenter request processor and or the audience response system presenter component.

15. The system as claimed in claim 13, wherein the presenter request processor further comprises:
a presenter request listener component that receives the messages from the Audience Request Sender and then sends the message to the audience response system presenter component; and
a presenter request sender component, which constantly listens to the requests coming from the presenter and sends the message to a audience request listener component.

16. The system as claimed in claim 13, wherein audience request processor further comprises:
an Audience request listener component, which receives requests coming from the presenter and sends it to all the audience connected to that presenter; and
an Audience request sender component that accepts the message whenever a audience responds to the information using the audience response system audience component.

17. The system as claimed in claim 9, wherein the audience response audience component further comprises:
a Audience Message Communicator that accepts messages from the audience request processor and or the Server and then sends it a Audience Message Interpreter for further processing;
a Audience Message Interpreter component that selects an appropriate Audience Interface Generator;
an Audience Interface Generator, which displays the information in appropriate format to the audience through the Audience user Interface; and
an Audience Interface, where audience can provide their inputs based on the information displayed through their communication device.

18. The system as claimed in claim 10, wherein the audience response system presenter component, the Server and or the audience response system audience component communicates with each other over network in a message format.

19. The system as claimed in claim 10, wherein the audience response presenter component further comprises:
a Server Message Processor that accepts the information shared by the interactive element of the presentation software and based on the type of information appends Information type and creates a message;
a Server Message Communicator that receives the message created by the Server Message Processor and then adds Meeting ID of the presenter to the message and sends it to the Server; and
a Server Message Logger.

20. The system as claimed in claim 10, wherein the Server further comprises,
a Presenter Request Processor which processes requests coming from the presenter and sends it to a audience request processor; and
a Audience Request Processor which receives processed requests from the presenter request processor and further sends it across to all the audience connected to that Meeting ID through the audience response system audience component.
